(19) United States
(12) Patent Application Publication
(10) Pub. No.: US 2019/0079911 A1
(43) Pub. Date: Mar. 14, 2019

(54) Multi-Author Document Collaboration

(71) Applicant: Stuart Schechter, Seoul (KR)

(72) Inventor: Stuart Schechter, Seoul (KR)

(21) Appl. No.: 16/126,261

(22) Filed: Sep. 10, 2018

Related U.S. Application Data
(60) Provisional application No. 62/558,307, filed on Sep. 13, 2017.

(51) Int. Cl. G06F 17/24; G06F 17/22; G07C 13/00

(52) U.S. Cl. CPC G06F 17/24; G07C 13/00; G06F 17/2288

(57) ABSTRACT

Techniques which may allow multi-author document collaboration are described. A large number of users, for example, millions of people, may submit proposals for changes to a document. Users may be enabled to vote on one or more proposals, or to vote to keep the document as it is. An algorithm may provide an automatic method to merge two potentially conflicting proposals.

### FIELD

This disclosure relates to multi-author document collaboration.

### BACKGROUND

Advocacy groups often recruit members to echo the group's message. For example, an advocacy group may ask constituents to deliver a scripted message to a representative or to sign a petition which the constituents played no role in drafting. Entities lack a modern and efficient way to maximize meaningful engagement in an ever-growing society.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, techniques for multi-author document collaboration. Multi-author document collaboration may enable numerous users to collaboratively draft or edit a document by submitting, reviewing, or voting on proposed changes to the document at any time during one or more revision rounds. In one implementation, multi-author document collaboration may provide default mechanisms for merging conflicting proposals. After a revision round, multi-author document collaboration may generate a new version of the document resulting from changes made during the previous revision round.

Multi-author document collaboration may maximize meaningful engagement. For example, it may allow an entity and millions of constituents to collaboratively draft a petition or write and vote on key sections of a voter initiative, among other things.

### BRIEF DESCRIPTION OF THE DRAWINGS

The present description may be better understood from the following detailed description read in light of the appended drawings, wherein:

FIG. 1 is a flow diagram illustrating an example of a Multi-Author Document Collaboration proposal submission process.

FIG. 2 is a flow diagram illustrating an example of a Multi-Author Document Collaboration proposal review process.

FIG. 3 is a flow diagram illustrating an example of a Multi-Author Document Collaboration election management process.

FIG. 4 is an example of a user interface layout using a Multi-Author Document Collaboration process.

FIG. 5 is an example of a user interface layout using a Multi-Author Document Collaboration process.

FIG. 6 is an example of a user interface layout using a Multi-Author Document Collaboration process.

FIG. 7 is an example of a user interface layout using a Multi-Author Document Collaboration process.

FIG. 8 is a block diagram illustrating an example of a system capable of supporting a Multi-Author Document Collaboration process.

FIG. 9 is a component diagram of a computing device which may support a Multi-Author Document Collaboration process.

### DETAILED DESCRIPTION

A more particular description of certain implementations of Multi-Author Document Collaboration may be had by references to the implementations shown in the drawings that form a part of this specification, in which like numerals represent like objects. [001 7] The illustrated operations in the description show certain events occurring in a certain order. One skilled in the art will recognize that certain operations may be performed in a different order, modified or removed. Moreover, steps may be added to the described logic and still conform to the described implementations.

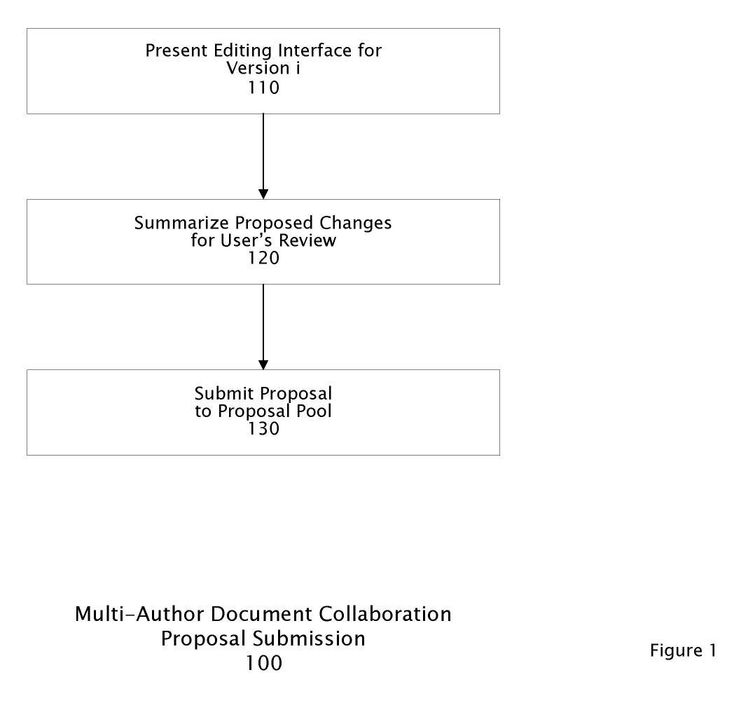

FIG. 1 is a flow diagram illustrating an example of a Multi-Author Document Collaboration process for Proposal Submission 100. Multi-Author Document Collaboration may provide techniques for an entity to engage numerous users, for example, millions of people, to collaboratively draft or edit a document. Users may collaborate by simultaneously performing one or more of the following actions: Users may submit proposed changes to the document in the form of one or more proposals; review proposals submitted by others; or vote to accept, reject, or merge proposals during one or more revision rounds.

Prospective users may discover Multi-Author Document Collaboration processes by receiving an email containing a link, via a link on a social media site, via a web search, or another means. Users may be unpaid, paid, professional, or non-professional individuals or entities who may or may not receive consideration for their participation. Multi-Author Document Collaboration may provide configuration options to allow any member of the public to participate in a revision round. A configuration option may restrict a set of individuals who may submit proposals, or it may restrict a set of individuals who may review or vote on proposals submitted by others.

A Multi-Author Document Collaboration user interface may display a title, name, web page URL, or rich text describing a purpose of a document or rules for drafting or editing the document. The user interface may provide a prompt inviting the public to help write a petition, for example. Multi-Author Document Collaboration may be enabled on, for example, a website, mobile website, mobile application, or as an add-on to a word processing program. Multi-Author Document Collaboration may include written, printed, or electronic matter in any media format. The user interface may include an editing interface to enable users to submit proposals or to review and vote on proposals submitted by others, among other actions.

At Step 110, Multi-Author Document Collaboration may present an editing interface for Version i of a document. Version i may be a most recent version of the document at a start of a revision round. In one implementation, “i” may represent a version number of the document. For example,“i” may equal 1, in which case Version i may be a first version of the document and may be described on the user interface as “Version 1.” A first version of the document may be a blank or initial draft of the document, for example, and may be a starting point for collaboration.

In one implementation, a user may propose changes to Version i by editing the document directly in the Multi-Author Document Collaboration editing interface. For example, the user may click on the text of the latest version to receive a cursor and begin editing. In another implementation, a user may propose changes to Version i by first selecting a “Propose Changes” button, for example, to begin editing. Multi-Author Document Collaboration may support proposed changes that delete content, introduce new content, move content, make grammatical or substantive changes, or reformat content, among other things. A set of one or more proposed changes submitted by a user in a given revision round may, together, form the user's proposal to change Version i. A user may submit one or more proposals during one or more revision rounds. If two or more proposed changes are related and only make sense if incorporated into the document together, a user may submit them in one proposal. Proposed changes submitted together in a single proposal may typically share a common fate: the proposal may either be selected and incorporated into the document, or rejected, for example. If two proposed changes are unrelated to each other, they may be submitted in different proposals. That way, if other users like one set of proposed changes, but not the other, they may vote to keep the set of changes they like and reject the set they don't like.

Multi-Author Document Collaboration may enable a user to submit one or more proposals to change Version i of the document at any time in a given revision round, so long as a deadline for submitting proposals has not passed. In one implementation, Multi-Author Document Collaboration may never impose a deadline for submitting a proposed change until after at least one proposal has received sufficient votes among voters indicating that the proposal is preferred to inaction, in other words, preferred to leaving Version i of the document unchanged. A proposal manager may designate such a proposal as being in a “Preferred to Inaction” state.

Multi-Author Document Collaboration may enable users to join or leave a revision round at any time. Multi-Author Document Collaboration may start a first revision round when an administrator clicks start, when a requisite number of users have signed in, upon occurrence of an event, at a predetermined date and time, or other options. New revision rounds may begin immediately after earlier rounds end, and a transition to a new round may not stop user participation. For example, when a new revision round begins, users actively participating in a previous round may automatically become participants in the new round, and Multi-Author Document Collaboration may provide a new version, for example, Version i+1, of the document which users may collaboratively draft or edit.

Multi-Author Document Collaboration may limit a number of words or characters in a proposal or prevent changes that may cause Version i of a document to exceed a limit on the number of words, characters, bullet points, sections, or other constraints. Multi-Author Document Collaboration may limit formatting options, for example, fonts or font sizes, to encourage users to focus on content. Multi-Author Document Collaboration may emphasize formatting elements that help structure and clarify content, such as bullet points, paragraphs, and headings, for example.

At Step 120, Multi-Author Document Collaboration may summarize a user's proposed changes resulting from the user's edits for the user's review. In one implementation, Multi-Author Document Collaboration may display a user's edits as proposed changes in a side panel, or another location, as a user edits Version i of the document in the editing interface. In another implementation, Multi-Author Document Collaboration may summarize the changes after the user has finished editing and chosen to preview the changes. After a user previews the user's proposed changes, Multi-Author Document Collaboration may enable the user to submit the changes, return to the editing interface to revise the proposal, remove changes directly from the preview, or abandon the proposed changes, for example. Multi-Author Document Collaboration may allow users to share statements in support of, or opposition to, proposals to change Version i.

The Multi-Author Document Collaboration system may display to users a number of proposals that have been submitted, a number of elections that require votes, a list of users who still need to vote, a number of elections which a particular user still needs to vote on, or other information that indicates progress being made to reach a next version. The system may alert users when there are elections that they need to vote on, for example, by displaying an alert bar.

The system may allow users reviewing a version to see each change that was made, the proposal that contains each change, authors of the proposal, and results of all elections that led to the proposal being accepted, possibly including each of the individual votes in each election. The system may provide similar information about changes and proposals that were not allowed to become part of the new version.

In another implementation, Multi-Author Document Collaboration may limit an amount of time during which a user may submit proposals in a given round. Proposal submissions may be limited to a relative time from a start of a revision round, or it may set a deadline to an absolute time, for example.

At Step 130, Multi-Author Document Collaboration may submit a user's proposal to a proposal pool. The proposal pool may include proposals submitted by one or more users in one revision round. Multi-Author Document Collaboration may subject proposals in the proposal pool to elections, which may determine user preferences or resolve conflicts between proposals. For example, an election may ask users to vote to indicate a preference for changing Version i of the document as specified by a proposal, or not making the changes (a Proposal vs. Inaction election), vote to indicate their preference between two proposals (Proposal vs. Proposal election), or vote to indicate preference between choosing a single proposal or merging two proposals.

Types of conflicts may include, for example, an insertion in one proposal in a region deleted by another proposal, two different insertions in the same position, or two different substitutions for the same word or phrase from two different proposals. Stronger conflicts may be those that are harder to resolve, while weaker conflicts may be easier to resolve, while preserving the semantics of both proposals.

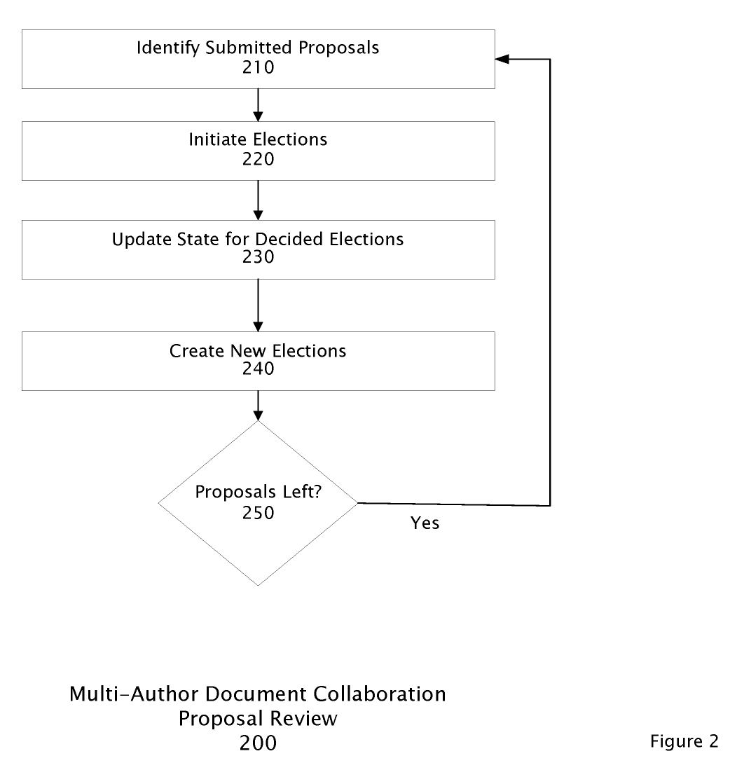

FIG. 2 is a flow diagram illustrating an example of a Multi-Author Document Collaboration process for Proposal Review 200.

At Step 210, a Multi-Author Document Collaboration process for managing proposals, for example, a proposal manager, may identify newly-submitted proposals in the proposal pool. The proposal pool may include proposals submitted by multiple users before a proposal submission deadline of a revision round.

At Step 220, the proposal manager may initiate elections to determine whether Multi-Author Document Collaboration will incorporate a proposal into a next version of a document, for example, Version i+1. The elections may help the proposal manager reduce the set of submitted proposals to a set of proposals that are preferred to inaction and do not contain changes that conflict with other proposals in the set. At any time after a user submits a proposal, other users may participate in one or more elections pertaining to that proposal.

In one implementation, Multi-Author Document Collaboration may enable a user to participate in an election by providing an interface for a user to review proposals submitted by other users and to vote to keep or discard the set of proposed changes in the other users' proposals. A user who submitted a proposal, the user's friends, or other parties with whom the user may have a conflict of interest, may be prohibited from voting on elections related to that proposal.

At Step 230, the proposal manager may update a state of a proposal based on a result of a decided election. The proposal manager may initiate one or more types of elections, which may determine a state of a proposal. For example, the proposal manager may initiate a Proposal vs. Inaction election, which may determine whether a proposal is preferred to leaving Version i of the document unchanged. A Proposal vs. Inaction election may be summarized as a binary choice between keeping all the proposed changes in the proposal or discarding all the proposed changes in the proposal. A Proposal vs. Inaction election may filter out proposals that a consensus of voters deems undesirable.

If the proposal wins a Proposal vs. Inaction election, then the proposal manager may update that proposal to a Preferred to Inaction State, assuming another election has not already caused the proposal to be discarded or replaced. If the proposal loses a Proposal vs. Inaction election, and the proposal is not preferred to inaction or to another proposal, the proposal manager may update that proposal to a Discarded State.

A Proposal vs. Proposal election may ask a user to vote to indicate a preference for one of two conflicting proposals, for example, a Proposal A or a Proposal B. Two proposals to change Version i of the document may conflict if they contain conflicting proposed changes. For example, if Proposal A contains a proposed change to insert text into a third paragraph of Version i of Document, and Proposal B contains a proposed change to delete the third paragraph of Version i of Document, there may be no semantically correct way to merge the intent of the two changes, or the correct choice may be subjective. It may not be a conflict if Proposal A and Proposal B include the same proposed changes, for example, deleting the same region, substituting the same replacement text for the same original, performing the same restyling, moving the same region, or inserting the same text. In this case, Proposal B may be skipped or disregarded, for example.

A Proposal vs. Proposal election involving Proposal A and Proposal B may have three possible outcomes: Proposal A may win, Proposal B may win, or a preference for a merged proposal, which merges Proposal A and Proposal B, may win. If the preference for a merged proposal wins, then the proposal manager may update the losing proposals, Proposal A and Proposal B, to a Replaced State. In one implementation, Multi-Author Document Collaboration may provide a default mechanism to merge one or more conflicting proposals automatically.

In one implementation, the proposal manager may hold a Proposal vs. Inaction election before a Proposal vs. Proposal election. In another implementation, the proposal manager may hold a Proposal vs. Proposal election first, followed by an election between a winning proposal and inaction, for example, a Proposal A vs. Inaction election or a Proposal B vs. Inaction election. This implementation may verify that surviving proposals are preferable to Version i of the document. In another implementation, the system may assume that if Proposal A is preferred over Proposal B, and Proposal B was preferred to inaction, then it may not be necessary to test whether Proposal A is preferred over inaction, as the proposal manager may conclude, through transitivity, that the winning proposal, Proposal A, is also preferred to inaction. In such case, the proposal manager may move the winning proposal to the Preferred to Inaction State if the winning proposal had not been subject to a Proposal vs. Inaction election, but the losing proposal was already in a Preferred to Inaction State before the election. Otherwise, the proposal manager may keep the winning proposal in whichever state it started in and update the losing proposal to either a Discarded State or a Replaced State.

At Step 240, the proposal manager may determine whether there are no more conflicting proposals in the Preferred to Inaction State and whether there are no more submitted proposals that remain to be tested against inaction. If the answers to both questions are yes, then the proposal manager may update proposals in the Preferred to Inaction State to an Accepted State. The proposal manager may incorporate proposals having an Accepted State into a new version of the document, for example, Version i+1.

Multi-Author Document Collaboration may provide a default mechanism for merging two proposals while resolving their conflicts, but given the subjectivity of choices for doing so, it may not guarantee that users will prefer a choice to merge proposals using this mechanism over the choice of choosing one proposal to survive and discarding the other.

In one implementation, Multi-Author Document Collaboration may assign priorities to determine an order in which conflicting proposals may be identified. Participants may be less likely to vote to merge proposals with higher priority conflicts than those, for example, having lower priority values, as these conflicts may represent more significant differences. Multi-Author Document Collaboration may run elections on proposals with higher priority conflicts before those with lower priority conflicts, all things being equal, for example, as doing so is more likely to reduce the number of proposals to resolve in the pool.

At Step 240, the proposal manager may determine whether all proposals have been decided upon. If at Step 250 there are still proposals left, Proposal Review 200 process may be run again. If there are not enough elections to provide votes to voters, the proposal manager may create new elections to either resolve whether proposals are preferred to inaction or to resolve conflicts.

If the deadline for new proposals has passed, all proposals have been either discarded, replaced, or moved to the preferred-to-inaction state, and all conflicts are resolved such that there is no proposal in the preferred-to-inaction state which conflicts with another proposal in that state, the Multi-Author Document Collaboration system may generate and present Version i+1 of the document on the user interface as the most recent version of the document. Version i+1 of the document may be a subsequent version of the document, for example, “Version 2,” resulting from changes made to Version i of the document in the revision round that just ended. Each subsequent Version i of the document may be a copy of Version i+1 of the document from a previous revision round.

After an election is created, underway, and decided, then the election may be retired.

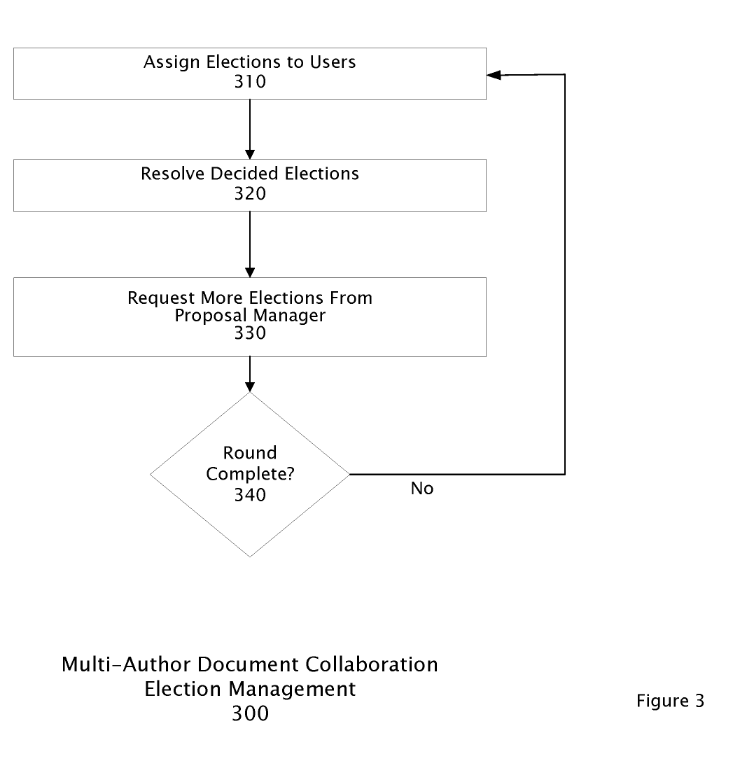

FIG. 3 is a flow diagram illustrating an example of a Multi-Author Document Collaboration process for Election Management 300. At Step 310, an election manager may assign users to vote on elections. At Step 320, Multi-Author Document Collaboration may cancel the assignment of elections to users when the outcomes of those elections have been decided, for example, when the users who have already voted have created a large enough margin of victory to determine the outcome. These users may need to be assigned a new election to vote on when possible.

At Step 330, the election manager may assign additional users to vote on elections based on the estimated number of votes needed to decide an election. It may generate estimates by examining the votes received so far, such as by requiring more new votes when the existing votes are closely split and fewer new votes when existing votes strongly favor one outcome.

At Step 340, if there are not enough elections, for example, if there are fewer votes needed than voters, the election manager may request the proposal manager to create more elections. When an election is decided, the election manager may assign another election to users who have yet not started reviewing the election. If either there are elections left, or there are no elections left but the proposal manager may create more elections, a revision round may be incomplete at Step 340, and the process may continue with Step 310.

When a vote is recorded, a process receiving the user's request to record the vote, for example, a vote recorder, may update the vote count in a location dedicated to storing vote counts for the election, for example, a database record or a Redis entry. The vote recorder may load the vote counts and determine whether current votes are sufficient to decide the election. If the votes are sufficient, the vote recorder process may update the election from the Underway State to a Decided State.

The proposal manager may update a proposal set based on a result of a decided election and then update that election to a Retired State.

If all proposal and election conflicts are resolved, then the proposal manager may present Version i+1 of the document as the most recent version of the document on the user interface.

Voting may occur multiple times throughout a revision round. The number of votes required to decide an election may vary depending on a ratio of votes for different outcomes. The greater the difference between a most-popular outcome and a next-most-popular outcome, the fewer votes may be needed to establish which outcome is preferred. In one implementation, Multi-Author Document Collaboration may use Wald's technique for sequential analysis to adjust a number of votes needed based on the ratio of votes for each outcome. In one implementation, Multi-Author Document Collaboration may impose a bound on a maximum number of votes allowed to ensure that voting reaches an outcome, even if options are equally popular. The system may decide elections when the number of votes for one outcome is X votes greater than the number of votes for the outcome with the next largest number of votes, for some X (a win-by X rule) and/or when a maximum vote count has been reached.

Multi-Author Document Collaboration may assign a weight to each voter. In one implementation, all voters may have equally-weighted votes. In another implementation, more weight may be given to voters who have a long history of participation in a Multi-Author Document Collaboration process or whose past votes have closely aligned with a group's consensus, for example. Assignment of weight to votes or voters may reduce the power of people, for example, “trolls,” who may attempt to create or vote for proposals that run contrary to an entity's objectives. Assignment of weight may also reduce a number of votes needed to conclude that a proposal is popular with voters.

For example, if a user's votes typically correlate with 75% of past proposals passing, then that user may get one vote. If a user's votes typically correlated with 90% of proposals passing, that user may be a very good predictor of whether a particular proposal will likely pass or fail; thus, Multi-Author Document Collaboration may have a higher weighted vote or may be allowed more votes. In contrast, if a group of users that is trying to interfere with the process manage to receive 40% of the vote, Multi-Author Document Collaboration may assign that group a lower weight than other voters, since their voting may not have aligned with the group's past consensuses. Multi-Author Document Collaboration may assign weight to voters depending on any other voter characteristics or other factors, for example.

In one implementation, Multi-Author Document Collaboration may impose a voting threshold required for a proposal to pass. Assignment of a threshold may be an ongoing process, as some votes may end before other votes begin. A threshold may determine whether a proposal is sufficiently popular over Version i of a document. In one implementation, a threshold may require that a proposal receive a minimum percentage of supporting votes to pass. Voting thresholds may increase in subsequent rounds of voting. For example, a proposal may need 51% of votes to pass in a first round and need an additional 1% each round until reaching 66.66%. This may result in a final document which users largely agree upon or which strongly reflects an entity's viewpoints or objectives.

The system may display to users the number of proposals that have been submitted, the number of elections that require votes, who still needs to vote, how many elections the user who has logged in still needs to vote on, and other information that indicates the progress being made to reach the next version. The system may alert users when there are elections that they need to vote on.

The system may allow users reviewing a version to see each change that was made, the proposal that contains each change, the authors of the proposal, and the results of all elections that led to the proposal being accepted, possibly including each of the individual votes in each election. The system may provide similar information about changes and proposals that were not allowed to become part of the new version.

A revision round may end when Multi-Author Document Collaboration determines which proposals submitted by a proposal deadline will make it into a next version, Version i+1 of the document. This may occur after a deadline to submit new proposals has passed, all surviving proposals to change the document have been determined to be preferred to the alternative of not making a change, and there are no unresolved conflicts between surviving proposals to change the document. A revision round may end when the set of proposals has been reduced to include only those proposals that have a consensus supporting them, for example, votes preferring the proposal over the most recent version of the document passed with a sufficient level of statistical certainty, and when no two proposals contain changes that conflict with each other in a manner that cannot be resolved automatically to the satisfaction of authors, for example, as determined by statistically sampled voting.

An administrator may decide when collaboration should stop, and no more revision rounds will take place. A revision may be the last revision round when a majority of voters support disallowing further revisions, after a predetermined date and time, after a revision round ending a certain number of hours from a start, or after a fixed number of rounds, for example.

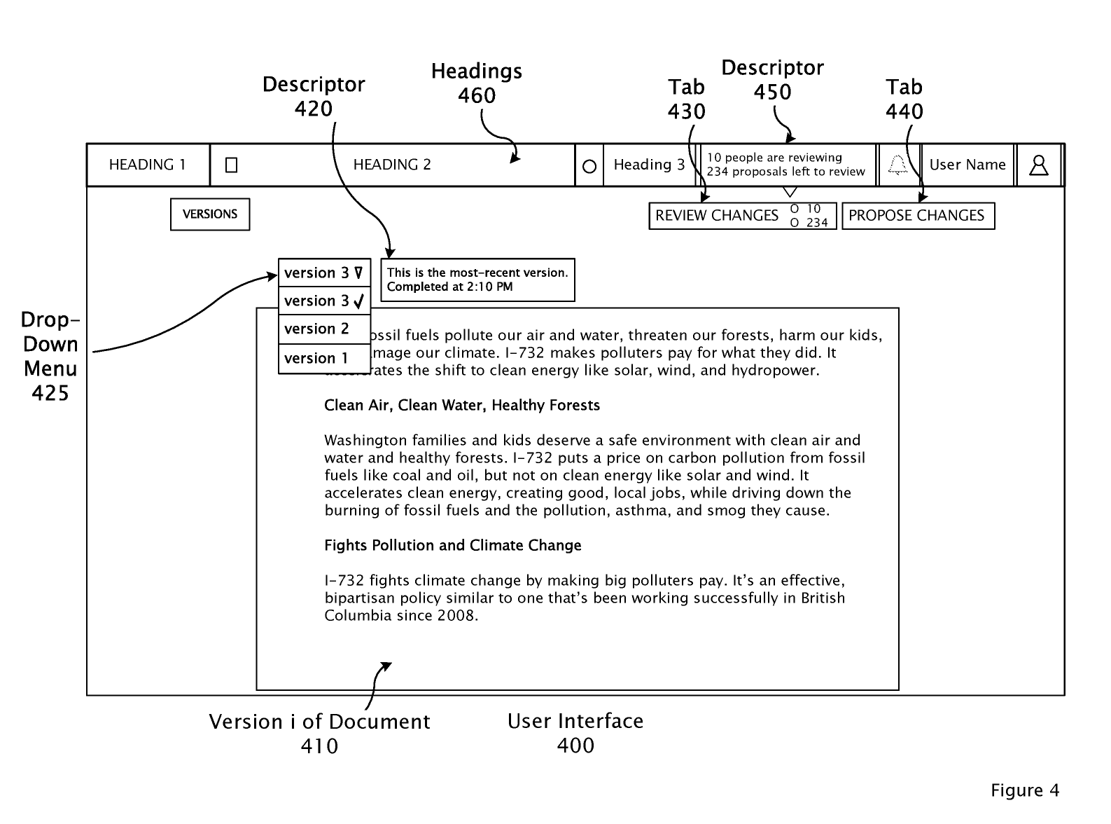

FIG. 4 is an example of a user interface layout using a Multi-Author Document Collaboration process. User Interface 400 may display Version i of Document 410. Descriptor 420 may indicate that Version i of Document is a most recent version of the document, for example, Version 3, and it may provide a time stamp indicating when that version was completed. Drop-Down Menu 425 may allow a user to view a different version of a document, for example, Version 1 or Version 2.

Tab 430 may be a button to “Review Changes,” for example, to allow a user to review or vote on proposed changes submitted by other users. Tab 440 may be a button allowing the user to “Propose Changes” to Version i of Document, for example, by editing the document in the user interface during time allowed in an editing round. In another implementation, users may propose changes by clicking on the text of the latest version to receive a cursor and begin editing. When there's something for the user to vote on (reviewing changes), an alert bar may appear, indicating the number of elections that the user needs to vote on.

User Interface 400 may include Descriptor 450, for example, an indicator showing a number of users reviewing Version i of Document or a number of proposals left to review. Headings 460 may include a name of an entity, document, or icons for alerts or a user profile, for example.

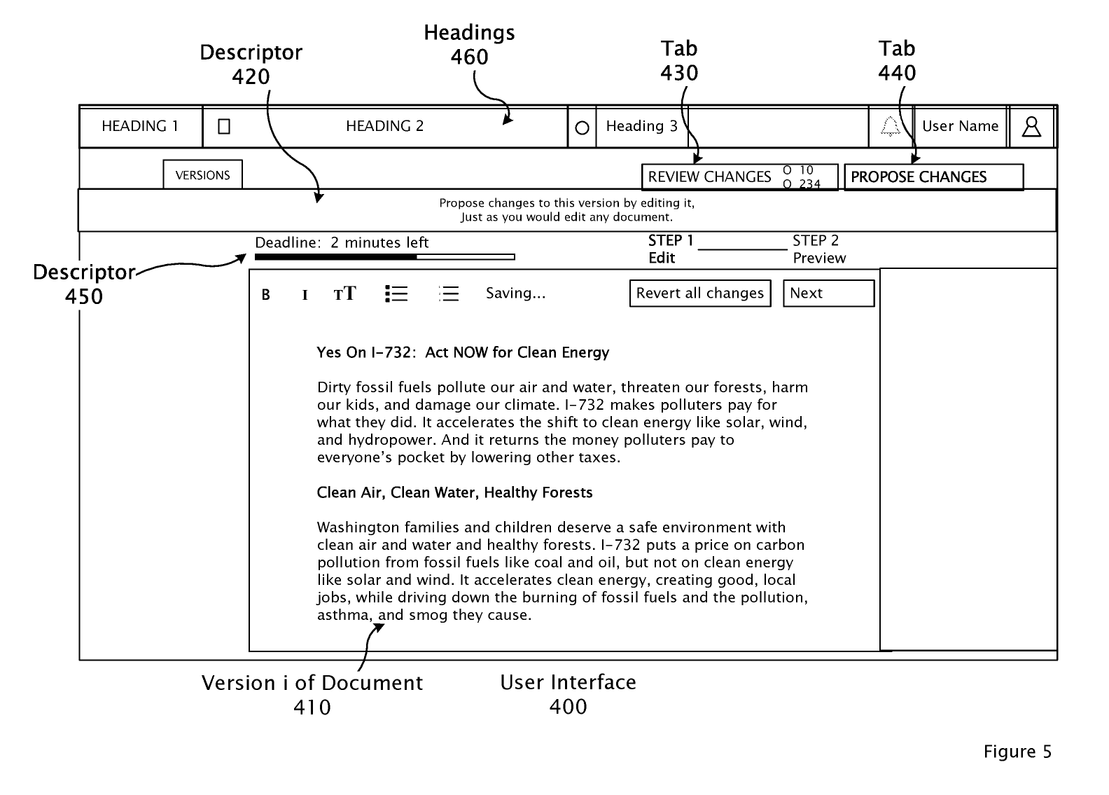

FIG. 5 is an example of a user interface layout using a Multi-Author Document Collaboration process. User Interface 400 may display Version i of Document 410, which may be a most recent version of the document being edited. Version i of Document 410 may be displayed with markup or as a clean copy.

An editing tool may enable a user to propose changes by editing Version i of Document Text 410 in User Interface 400. Descriptor 420 may include text inviting a user to propose changes to Version i of Document by editing its text in the user interface, just as the user would edit any document. Tab 430 may be a “Review Changes” button to allow a user to review or vote on proposed changes submitted by other users. Tab 440 may be a “Propose Changes” button allowing the user to propose changes to Version i of Document.

User Interface 400 may also include Descriptor 450, for example, an indicator showing a relative or absolute deadline for proposal submissions. Headings 460 may include a name of a company, advocacy group, document, or icons for alerts or a user profile, for example.

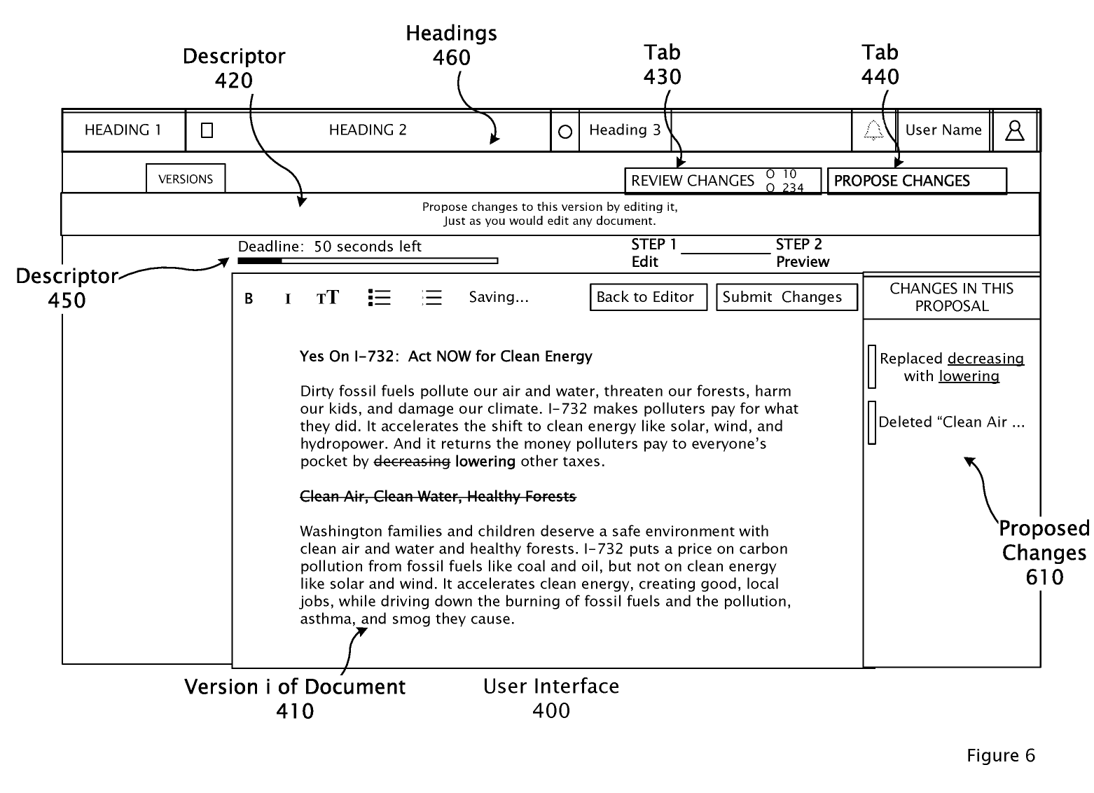

FIG. 6 is an example of a user interface layout using a Multi-Author Document Collaboration process. User Interface 400 may display Version i of Document 410, which may be a most recent version of the document being edited. Version i of Document 410 may be displayed with markup or as a clean copy.

An editing tool may enable a user to propose changes by editing Version i of Document Text 410 in User Interface 400. Descriptor 420 may include text inviting a user to propose changes to Version i of Document by editing its text in the user interface. Tab 430 may be a “Review Changes” button to allow a user to review or vote on proposed changes submitted by other users. Tab 440 may be a “Propose Changes” button allowing the user to propose changes to Version i of Document.

User Interface 400 may also include Descriptor 450, for example, an indicator showing a relative or absolute deadline for proposal submissions. Headings 460 may include a name of a company, advocacy group, document, or icons for alerts or a user profile, for example.

As a user edits Version i of Document 410, that user's edits may be displayed as Proposed Changes 610 in a side panel, or other location, on the User Interface 400. A proposal to change Version i of Document may consist of one or more individual proposed changes. For example, a user may delete content, introduce new content, make grammatical or substantive changes, or reformat content, among other things. A change may include insertion, deletion, replacement, movement, or reformatting of text, for example.

After previewing proposed changes, a user may have an option to return to the editor tool to make more proposed changes. A user may submit changes by hitting a “Submit Changes” button during a time allowed to submit proposals, or by another means of submission. A user may submit multiple proposals during any given revision round.

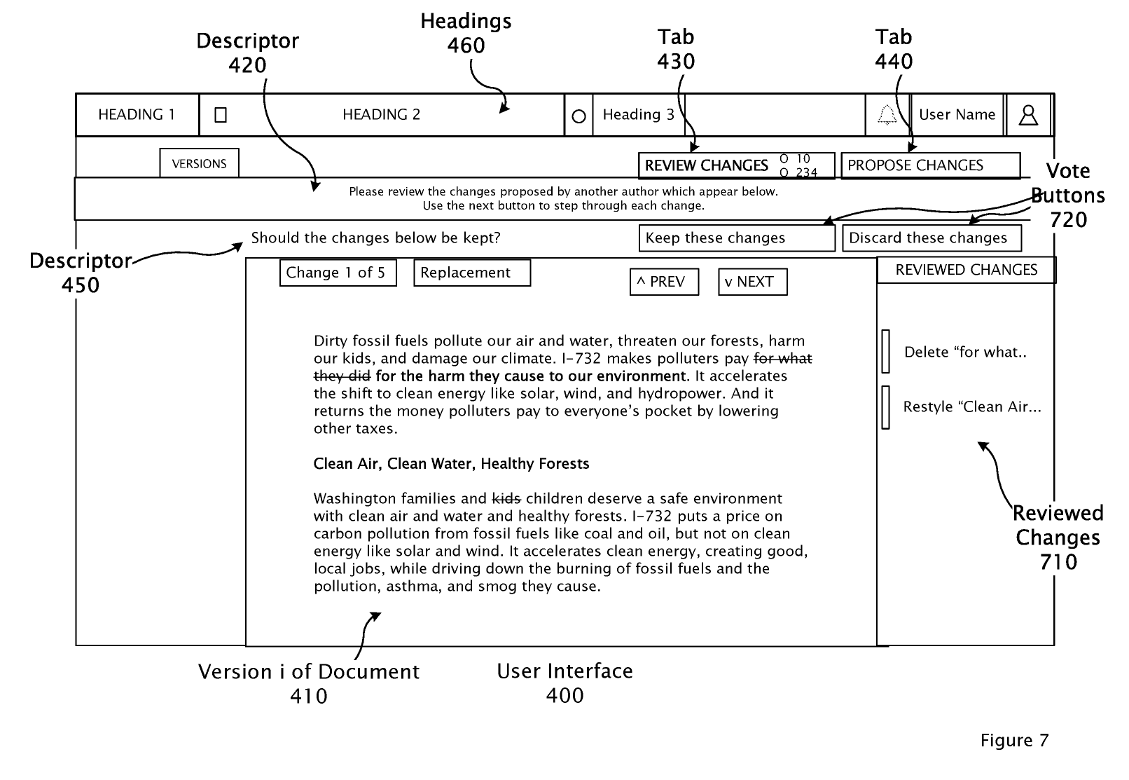

FIG. 7 is an example of a user interface layout using a Multi-Author Document Collaboration process. A user may choose to participate in an election by reviewing and voting on a set of proposed changes submitted by other users, for example, by clicking a “Review Changes” button in Tab 430. Descriptor 420 may include text inviting a user to review proposals submitted by one or more other users. The other users' proposed changes may be displayed as markups to Version i of Document 410 in User Interface 400, for example. Tab 430 may include a “Review Changes” button to allow a user to review and vote on proposed changes submitted by other users.

Descriptor 450 may ask a user to vote on whether to keep the other user or users' set of proposed changes. For example, Vote Buttons 720 may include a button to “Keep These Changes” or a button to “Discard These Changes.”

Headings 460 may include a name of a company, advocacy group, document, or icons for alerts or a user profile, for example.

As a user reviews changes, Version i of Document 410, Multi-Author Document Collaboration may display the proposed changes being reviewed as Reviewed Changes 710 in a side panel, or other location, on the User Interface 400. In another implementation, the user's votes to keep or discard the proposed changes may be displayed. A Multi-Author Document Collaboration election manager may receive and count a user's votes, and a proposal manager may initiate elections to resolve conflicts between proposals.

In one implementation, Multi-Author Document Collaboration may enable a user to begin participation in an election by selecting a “Review Changes” button on the user interface. After a user selects the “Review Changes” option, Multi-Author Document Collaboration may display a proposal submitted by a person other than the user. The user may view each proposed change and vote to keep or discard the set of proposed changes in the other user's proposal. The other user's proposal may include proposed changes to a current version of a document, for example, Version i of the document.

In one implementation, Multi-Author Document Collaboration may display the set of proposed changes in a proposal to change Version i of a document in an order in which they appear in the document. For example, a user may review proposed changes appearing earlier in the document before those later appearing in the document. Further, the proposal manager may initiate elections on proposals including proposed changes appearing earlier in the document before initiating elections on proposals including proposed changes appearing later in the document.

To reduce biases in favor of or against change, Multi-Author Document Collaboration may present elections as if proposed changes had already been made, and display the changes needed to undo the proposed changes as if they themselves were the proposed changes. For example, by showing half of those voting an election this reversed election, biases for or against change for the sake of change may cancel out.

Tab 440 may be a “Propose Changes” button allowing the user to propose changes to Version i of Document. A user may submit multiple proposals in any given revision round.

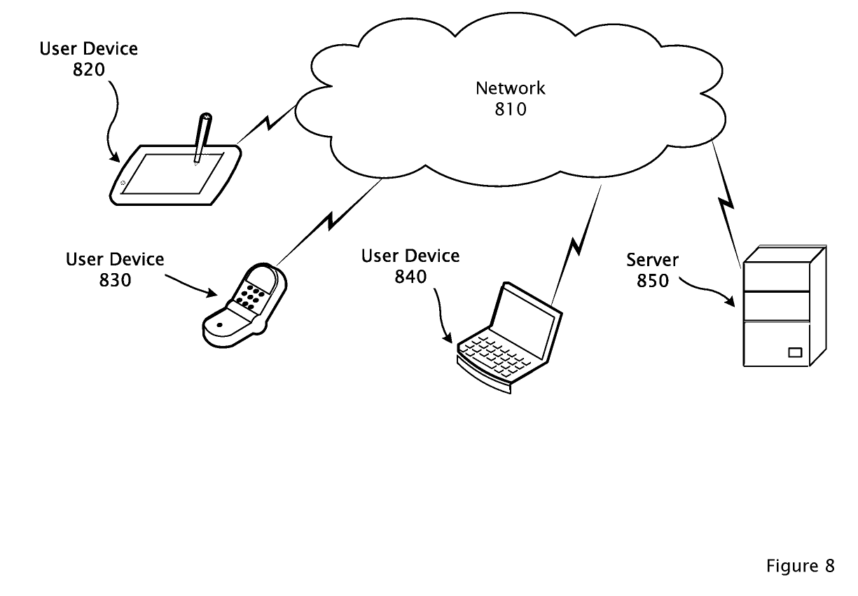

FIG. 8 is a block diagram illustrating an example of a system capable of supporting a Multi-Author Document Collaboration process. Network 810 may include Wi-Fi, cellular data access methods, such as 3G or 4GLTE, Bluetooth, Near Field Communications (NFC), the internet, local area networks, wide area networks, or any combination of these or other means of providing data transfer capabilities. In one implementation, Network 810 may comprise Ethernet connectivity. In another implementation, Network 810 may comprise fiber optic connections.

User Device 820, 830, 840 may have network capabilities to communicate with Server 850. Server 850 may include one or more computers and may serve a number of roles. Server 850 may be conventionally constructed or may be of a special purpose design for processing data obtained from Multi-Author Document Collaboration. One skilled in the art will recognize that Server 850 may be of many different designs and may have different capabilities.

User Device 820, 830, 840 may be used by authors contributing to a document, for example by accessing a website or executing an app. Server 850 may store the document, and may be used to host a website, allow editing of the document, execute conflict resolution rules, or perform other tasks. One having skill in the art will recognize that various configurations for User Device 820, 830, 840 and Server 850 may be used to implement Multi-Author Document Collaboration.

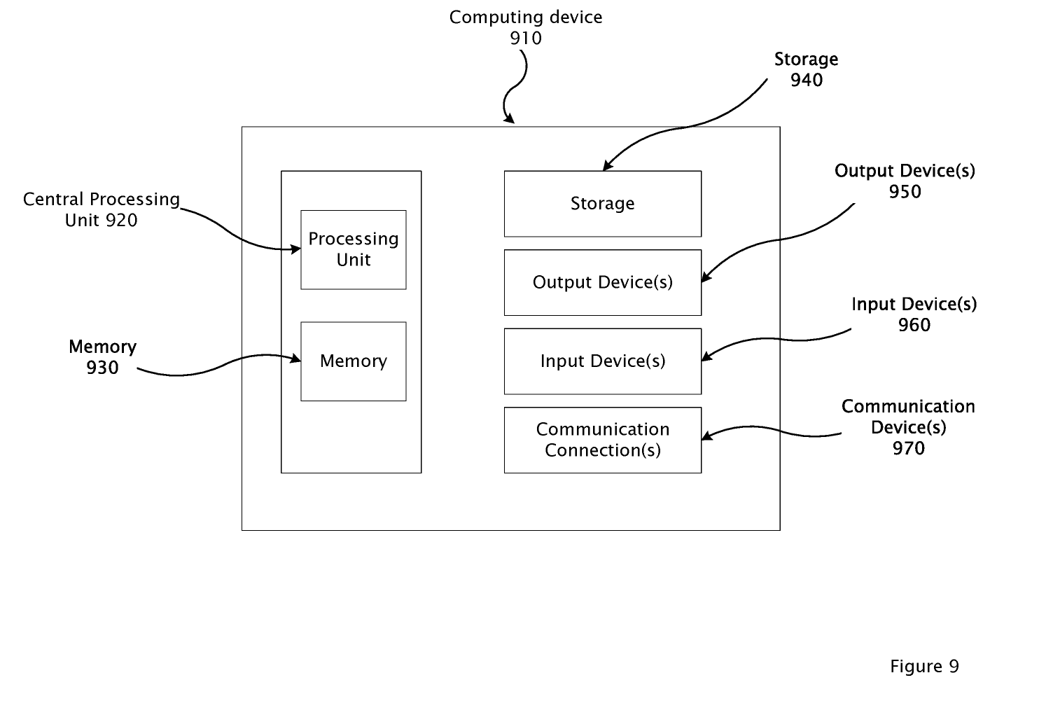

FIG. 9 is a component diagram of a computing device which may support a Multi-Author Document Collaboration process.

Computing Device 910 can be utilized to implement one or more computing devices, computer processes, or software modules described herein, including, for example, but not limited to a mobile device. In one example, Computing Device 910 can be used to process calculations, execute instructions, and receive and transmit digital signals. In another example, Computing Device 910 can be utilized to process calculations, execute instructions, receive and transmit digital signals, receive and transmit search queries and hypertext, and compile computer code suitable for a mobile device. Computing Device 910 can be any general or special purpose computer now known or to become known capable of performing the steps or performing the functions described herein, either in software, hardware, firmware, or a combination thereof.

In its most basic configuration, Computing Device 910 typically includes at least one Central Processing Unit (CPU) 920 and Memory 930. Depending on the exact configuration and type of Computing Device 910, Memory 930 may be volatile (such as RAM), non-volatile (such as ROM, flash memory, etc.) or some combination of the two. Additionally, Computing Device 910 may also have additional features/functionality. For example, Computing Device 910 may include multiple CPU's. The described methods may be executed in any manner by any processing unit in Computing Device 910. For example, the described process may be executed by both multiple CPUs in parallel.

Computing Device 910 may also include additional storage (removable or non-removable) including, but not limited to, magnetic or optical disks or tape. Such additional storage is illustrated by Storage 940. Computer-readable storage media includes volatile and nonvolatile, removable and non-removable media implemented in any method or technology for storage of information such as computer-readable instructions, data structures, program modules or other data. Memory 930 and Storage 940 are all examples of computer-readable storage media. Computer-readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by Computing Device 910. Any such computer-readable storage media may be part of Computing Device 910. But computer-readable storage media does not include transient signals.

Computing Device 910 may also contain Communications Device(s) 970 that allow the device to communicate with other devices. Communications Device(s) 970 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared and other wireless media. The term computer-readable media as used herein includes both computer-readable storage media and communication media. The described methods may be encoded in any computer-readable media in any form, such as data, computer-executable instructions, and the like.

Computing Device 910 may also have Input Device(s) 960 such as a keyboard, mouse, pen, voice input device, touch input device, etc. Output Device(s) 950 such as a display, speakers, printer, etc. may also be included. All these devices are well-known in the art and need not be discussed at length.

Those skilled in the art will realize that storage devices utilized to store program instructions can be distributed across a network. For example, a remote computer may store an example of the process described as software. A local or terminal computer may access the remote computer and download a part or all the software to run the program. Alternatively, the local computer may download pieces of the software as needed or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described implementations may be made without departing from the spirit and scope of the invention. Additionally, the illustrated operations in the description show certain events occurring in a certain order. In alternative implementations, certain operations may be performed in a different order, modified or removed. Moreover, steps may be added to the above-described logic and still conform to the described implementations. Further, operations described herein may occur sequentially, or certain operations may be processed in parallel. Yet further operations may be performed by a single processing unit or by distributed processing units.

1. A method, comprising:
receiving edits for a version of a document;
summarizing the received edits, giving a set of proposed changes to the document for review, wherein the set of proposed changes comprise a first proposal;
submitting the first proposal to a proposal pool;
creating an election;
assigning one or more users to vote in the election;
receiving one or more votes from the one or more users in the election;
determining when the election has received enough votes to be decided;
determining an outcome of the election if enough votes have been received, based on the received one or more votes; and
determining, based on the outcome of the election, if the first proposal will be accepted or discarded.

2. The method of claim 1, wherein if the outcome of the election is that the first proposal will be accepted, the first proposal is incorporated into the document.

3. The method of claim 1, wherein election outcomes are decided using statistical sampling to reduce a number of votes needed, and fewer votes are needed to reach a decision when existing votes favor one choice.

4. The method of claim 1, wherein proposed changes that move text are represented by using arrows to show that text has moved, as opposed to appearing to have been deleted from one location and added to the other.

5. The method of claim 1, further comprising:
submitting a second proposal to the proposal pool; and
determining, based on the outcome of the election, if the second proposal will be accepted or discarded.

6. The method of claim 5 in which an election is created for the first proposal and the second proposal before an election is created for a fourth proposal and a fifth proposal, the fourth proposal and the fifth proposal having weaker conflicts than the first proposal and the second proposal.

7. The method of claim 5, further comprising:
submitting a third proposal to the proposal pool, the third proposal comprising at least one change from each of the first and second proposals; and
determining, based on the outcome of the election, if the second proposal will be accepted or discarded.

8. The method of claim 5, wherein a user interface is provided showing changes needed to replace the first proposal with the second proposal and operable to allow users to indicate if they prefer to keep or discard those changes.

9. The method of claim 8, wherein arrows are used to indicate moved text if the second proposal contains text which is moved compared to the first proposal.
